(19) United States
(12) Patent Application Publication
(10) Pub. No.: US 2006/0018073 A1
(43) Pub. Date: Jan. 26, 2006

(54) Active protection against transients

(75) Inventor: Guy C. Thrap, Del Mar, CA (US)

Correspondence Address: Gregory J. Koerner;Redwood Patent Law, 1291 East Hillsdale Boulevard, Suite 205, Foster City, CA, 94404, US

(73) Assignee: Maxwell Technologies, Inc.

(21) Appl. No.: 11/087,112

(22) Filed: Mar. 23, 2005

Related U.S. Application Data
(60) Provisional application No. 60/590,893, filed on Jul. 23, 2004.

(51) Int. Cl. H02H 9/06

(52) U.S. Cl. 361/118

(57) ABSTRACT

A circuit is provided for protecting double-layer capacitors in applications that are subject to transients. Predetermined thresholds can be set to protect the double-layer capacitors from the transients and concomitant damage that may occur.

### RELATED APPLICATIONS

The present Application is related to and claims priority from Provisional Application 60/590893, filed 23 Jul. 2004, Attorney Docket Number M170P, which is commonly assigned and incorporated herein by reference.

### SCOPE OF THE INVENTION

The present invention is generally related to protection against transients and more particularly related to protection of capacitors against transients.

### BACKGROUND

Double-layer capacitors, which are also known as ultracapacitors and supercapacitors, are now able to be manufactured with capacitance ratings in the hundreds and thousands of farads. Double-layer capacitors are capable of supplying or accepting larger currents, and have larger power densities and longer lifetimes than batteries. As well, double-layer capacitors have a wider operating temperature range than batteries, and are more easily disposed of than batteries. However, individual double-layer capacitor cells are limited by physics and chemistry to a maximum operating voltage of about 4 volts, and nominally to between about 2.5 to 3 volts. To achieve higher voltages, double-layer capacitors are typically connected in series.

Battery technologies are used in many applications by the automotive and vehicular industries. For many reasons, some related to performance, others to economy, vehicle manufacturers are looking at double-layer technology as a supplement and/or replacement for some or all of the functionality that is presently provided by other sources of energy.

As is known to those skilled in the art, prior to integration into vehicular systems, most electrical devices and circuits are subjected to a number of standardized tests. An example of the types of tests that can be performed is embodied by SAE J1455, published August 1994 by the Truck And Bus Electrical Systems Subcommittee, the particular details of which may be obtained from SAE International, 400 Commonwealth Drive Warrendale, Pa. 15096-0001 USA, as a document entitled “Joint SAE/Tmc Recommended Environmental Practices for Electronic Equipment Design (Heavy-Duty Trucks).” SAE J1455 includes characterizations of the performance and reliability of vehicle and tractor/trailer electronic components under different types of transients. Such transients may originate from natural and vehicle-induced sources in particular climatic, dynamic, and electrical environments.

SAE J1455 includes a number of vehicular electrical system tests that can be used to help determine performance characteristics when dump, inductive switching, and mutual coupling transients are present. After characterization, data obtained under SAE J1455 can be used to design vehicular electrical systems that are able to withstand expected peak voltage, peak current, source impedance, repetition rate, and frequency of event occurrence that may occur at interfaces between a particular component and an electrical distribution system.

In one SAE J1445 qualification test, an expected peak voltage is applied to a system so as to simulate transient voltages that may appear across electrical components during normal and abnormal conditions that might occur during a vehicle's operation, for example, as during starting or as when a voltage regulator might malfunction. As well, the electrical energy sources that are used to power the components can be characterized under SAE J1455. Large electrical devices, such as alternators and starter type batteries, are typically more easily qualified under SAE J1455 because of their inherent ability to better absorb large bursts of transient energy. For the same transient, smaller components and electrical sources of energy are less able to absorb energy and, thus, can be damaged more easily. For this reason, many smaller components are typically protected by fuses, or the like. When a fuse blows, until it is replaced or reset, any inline components or devices remain non-functional.

In part, because double-layer capacitor technology has not been considered as a viable supplement or replacement for battery technology, protection of double-layer capacitors and devices connected thereto against transients, for example as batteries may be subject to, has not been addressed.

### FIGURES

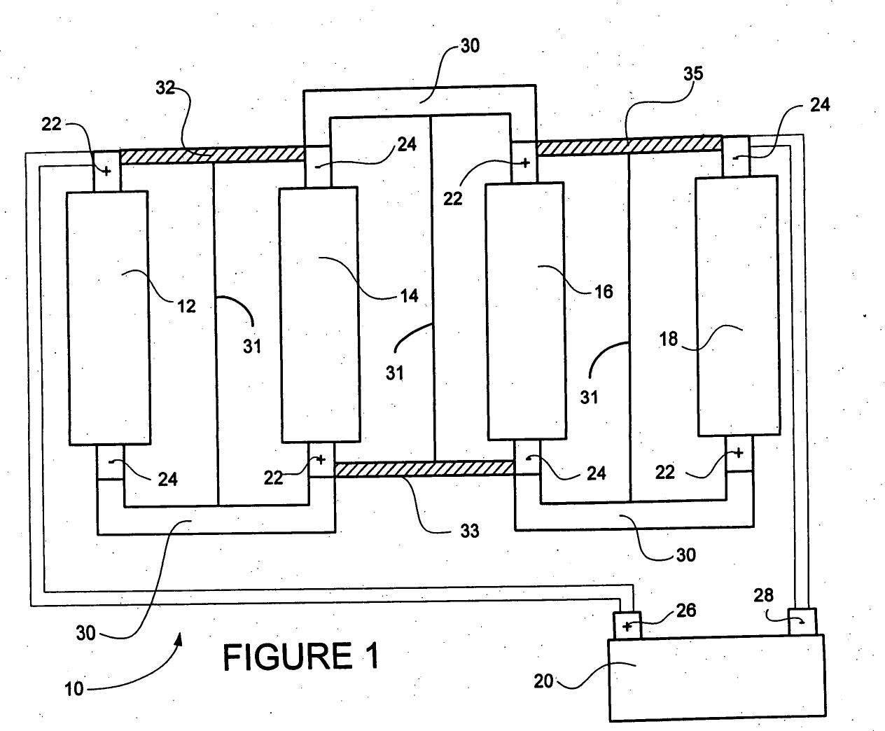

In FIG. 1 there is seen a series string of four double-layer capacitor cells.

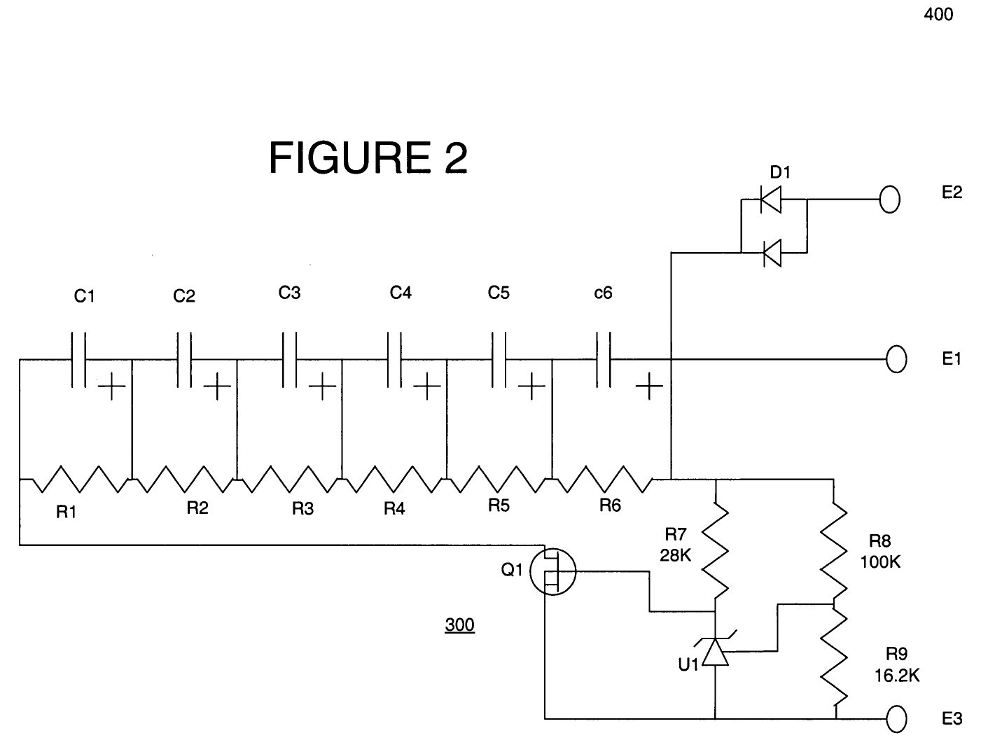

In FIG. 2 there is seen in schematic form an exemplary embodiment of a capacitor transient protection circuit used to protect a series connected string of capacitors.

### BRIEF SUMMARY

In anticipation of novel and new applications in which double-layer capacitor technology may be used, the present invention provides apparatus and methods for protection o such technology and the systems they may be used in against damage from transient signals.

A circuit is provided for protecting double-layer capacitors in applications that are subject to transient signals. Predetermined thresholds can be set to protect the double-layer capacitors from the transients and, thus, any concomitant damage that may occur.

In one embodiment, an apparatus for protecting devices against transient events comprises: a first circuit, the first circuit for receiving a signal, wherein the first circuit prevents at least one capacitor from accumulating charge during a period of time during when the signal is in a first range, and wherein the first circuit allows the at least one capacitor to accumulate charge during a period of time when the signal is in other than the first range. The first range may comprise an overvoltage. The at least one capacitor may comprise a double-layer capacitor. The apparatus may comprise a second circuit, wherein the at least one double-layer capacitor is functionally coupled to the second circuit to provide power to the second circuit during a period of time when the signal is in a second range. The second range may comprise an under-voltage. The overvoltage may comprise a transient condition as determined under SAE J1445. The at least one capacitor may comprise two or more series connected capacitors. The two more series connected capacitors may comprise two or more series connected double-layer capacitors, and the two or more series connected double-layer capacitors may be functionally coupled to one or more capacitor charge balancing circuit.

In one embodiment, a system in which double-layer capacitor technology is used comprises: a source for providing a first voltage; at least one device connected to the source; and at least one double-layer capacitor, the at least one double-layer capacitor functionally coupled to the device to provide a second voltage to the device. During one or more period of time the first voltage may be an under-voltage. The device may further comprise a circuit, the circuit receiving the first voltage, wherein the first circuit prevents at least one double-layer capacitor from accumulating charge during a period of time during when the first voltage is in a first range, and wherein the first circuit allows the at least one double-layer capacitor to accumulate charge during a period of time when the first voltage is in other than the first range. The source may comprise a vehicular battery. The first range may comprise an overvoltage. The system may comprise a vehicle. The at least one capacitor may be used as backup-source of power or energy.

In one embodiment, a method of providing backup power comprise the steps of: providing a primary source of voltage; providing a backup source of voltage; providing a load; coupling the backup source to the primary source and to the load to provide voltage to the load when a voltage at the primary power source falls below a certain threshold; providing a transient detection circuit; coupling the primary source and the secondary source to the transient detection circuit; stopping the backup source from accepting charge during transient conditions detected by the transient detection circuit. The transient condition may be a transient condition characterized by SAE J1455. The backup source may comprise one or more double-layer capacitor. The primary source may be provided in a vehicle. The transient condition may comprise a voltage that is greater than about 18 volts.

These and other features and aspects of the present invention will be better understood with reference to the following description, drawings, and appended claims.

### DESCRIPTION

Referring now to FIG. 1, in one embodiment, four 2600 Farad 60 mm×172 mm|1525 g|double-layer capacitors 12, 14, 16, 18 are coupled to comprise a series connected string of four capacitor cells. To help maintain a equalized voltage provided by a source 20 across each cell, respective balancing devices 32, 33, 35 may be connected as illustrated. In one embodiment, balancing devices 32, 33, 35 may comprise active charge balancing circuits as are described in commonly assigned U.S. Pat. No. 6,806,686. It is identified that with a series string of double-layer capacitor cells that can be charged to 12 volts (for example, in an embodiment wherein a nominal operating voltage of each cell 12, 14, 16, 18 is about 3.0 volts), over 2000 amps of current can be accepted or generated by the cells. For this, as well as reasons such as derived from the use of new double-layer capacitor technologies described in co-pending and commonly assigned U.S. patent application Ser. No. 10/817,701 Docket Number M109US-GEN3BAT, which is incorporated herein by reference, double-layer capacitors can now be used to supplement and/or even replace, batteries in certain applications.

In applications that use relatively large sized double-layer capacitors, the capacitors would be expected to have the same or similar transient absorbing performance characteristics as that of similarly physically sized batteries. However, as known to those skilled in the art, double-layer capacitors can provide the same or similar performance to that of batteries, but in a smaller form factor. For this reason, when used as replacements for batteries, unanticipated transients may subject such smaller double-layer capacitors to damage, whereas when a properly sized larger sized battery was used, no damage would occur. Thus, when used as supplements or replacements for batteries, in vehicles or otherwise, it is identified that double-layer capacitors may be subject to damage from transients.

Commercial and non-commercial vehicles and devices used therein now utilize many types of electronic circuitry. For proper operation, these circuits typically require that a certain minimum circuit voltage be present. For example, when a starter motor is used to start a vehicle and the starter battery voltage may drop below such a minimum voltage. In anticipation of low voltage conditions, vehicle designers can provided separate back up battery power sources. These separate battery power sources are typically smaller and, thus, are less able to handle transient conditions under SAE J1455 than larger sized batteries such as starter batteries. Typical protection devices used to protect smaller backup battery power sources from transients include rudimentary in-line fuses and circuit breakers. However, when an in-line fuse or relay is blown or tripped, the backup battery power source's backup ability may be lost and, thus, any circuit powered by such may stop functioning, lose memory, need to be rebooted, and/or be damaged.

In one embodiment, six series connected 10 Farad 2.5 volt rated double-layer capacitors are used to provide electrical backup power for an electrical device. In one embodiment, the electrical backup power in the form of double-layer capacitors is provided to 12 volt circuits used in transportation vehicles. It is identified that compared to a battery backup power source, six series connected double-layer capacitors can provide as good or even better performance in a form factor that is smaller in size. As discussed above, with smaller size, susceptibility to transients becomes more of a concern. Although described as comprising 6 series connected double-layer capacitors that can provide backup power in 12 volt systems, it is understood that fewer or more capacitors could be connected in series so as to provide backup power, for example, as in 24 volts and 48 volts systems, and the like. In one embodiment, double-layer capacitors could be protected from such transients by the use of in-line fuses. If blown, however, such a fuse would disable the capacitors and circuit(s) it was connected to, until replaced or reset.

The present invention anticipates the need to protect double-layer capacitor technology from transients, for example, the same or similar types of transients that may are characterized under SAE J1455, as well, with appropriate modifications, under other conditions and in other applications, other types of transients.

The novel use of the present invention does not permanently disable or disconnect a particular power or energy source being used during overvoltage and/or other transient conditions, in that, after a transient condition ends, the apparatus allows the source to continue to operate normally.

Referring now to FIG. 2, there is seen in schematic form an exemplary embodiment of a backup and transient protection circuit coupled to a series connected string of capacitors. Particular connections, values, and components in the schematic of FIG. 2 are described herein with the level of detail as would be required by one skilled in the electronic arts to implement embodiments of the invention. As shown in FIG. 2, a series string of double-layer capacitors C1-C6 is connected between a power supply voltage (E2) and a ground (E3). At (E1), connection to a load device or circuit (not shown) that can utilize the voltage provided at (E2), or a backup voltage as provided by capacitors C1-C6 when they are charged, is made. In one embodiment, a transient backup and protection circuit 300 as described herein is provided for use in a vehicular embodiment 400. In other embodiments, connections to a transient and protection circuit is made in a non-vehicular environment. In the illustrated embodiment, the voltage at (E2) charges the capacitors to a voltage that is evenly distributed across the capacitors C1-C6 by respective balancing resistors R1-R6. During normal operation, for example, when the voltage provided by a primary power source connected at (E2) is about 15 volts, the voltage at the gate of U1 is less than its turn on voltage. In this condition, R7 supplies about 15 volts to the gate of Q1, which when turned on connects an end of a double-layer capacitor string C1-C6 to ground (E3). When the capacitor string is exposed to an overvoltage condition, for example as when an 18 volt dc transient signal or voltage is present at (E1), the voltage divider formed by R8 and R9 provides greater than 2.5 volts to the gate of U1; this condition causes U1 to turn on, which reduces the gate voltage to Q1 and thus turns Q1 off. When Q1 turns off, the negative end of the capacitor string is permitted to float to a positive voltage, which prevents the capacitor string from accumulating any additional charge and being damaged thereby. When the transient voltage condition ends, U1 turns off and Q1 turns on, returning the capacitor string to normal backup operation. In this manner double-layer capacitors C1-C6 may be protected in real-time from damage during possible harmful transient events and, thus, may continue to provide backup power to a load connected across (E1) and (E3), for example, as when the voltage at (E2) drops below a threshold voltage at which the load would no longer operate correctly.

Although discussed generally with reference to vehicles, it should be clear that the invention describe herein would find use in other applications and other transient conditions, and accordingly, the invention should not be limited other than by the Claims presented below. For example, it is identified that protection against transient conditions as covered by the scope of the claims applies to gas combustion powered vehicles, as well as to electric and hybrid type vehicles. As well, it is understood that protection against transient conditions could be used in other than non-vehicular environments wherein seamless protection of power sources and other types of devices against transients may be desired. Furthermore, the schematic described herein is intended only as an exemplary embodiment, whereby after having read the descriptions provided herein, one skilled in the art would be capable of making modifications to the various component elements and embodiments thereon to provide protection against transients other than those described herein and yet remain within the scope of the claims and their legal equivalents.

1. An apparatus for protecting devices against transient events, comprising:
a first circuit, the first circuit for receiving a signal, wherein the first circuit prevents at least one capacitor from accumulating charge during a period of time during when the signal is in a first range, and wherein the first circuit allows the at least one capacitor to accumulate charge during a period of time when the signal is in other than the first range.

2. The apparatus of claim 1, wherein the first range comprises an overvoltage.

3. The apparatus of claim 2, wherein the at least one capacitor includes a double-layer capacitor.

4. The apparatus of claim 2, wherein the apparatus comprises a second circuit, wherein the at least one double-layer capacitor is functionally coupled to the second circuit to provide power to the second circuit during a period of time when the signal is in a second range.

5. The apparatus of claim 14, wherein the second range comprises an under-voltage.

6. The apparatus of claim 2, wherein the overvoltage comprises a transient condition as determined under SAE J1445.

7. The apparatus of claim 1, wherein the at least one capacitor comprises two or more series connected capacitors.

8. The apparatus of claim 7, wherein the two more series connected capacitors comprise two or more series connected double-layer capacitors, and wherein the two or more series connected double-layer capacitors are functionally coupled to one or more capacitor charge balancing circuit.

9. A system in which double-layer capacitor technology is used, comprising:
a source for providing a first voltage;
at least one device connected to the source; and
at least one double-layer capacitor, the at least one double-layer capacitor functionally coupled to the device to provide a second voltage to the device.

10. The system of claim 9, wherein during one or more period of time the first voltage is an under-voltage.

11. The system of claim 9, further comprising a circuit, the circuit receiving the first voltage, wherein the first circuit prevents at least one double-layer capacitor from accumulating charge during a period of time during when the first voltage is in a first range, and wherein the first circuit allows the at least one double-layer capacitor to accumulate charge during a period of time when the first voltage is in other than the first range.

12. The system of claim 11, wherein the source comprises a vehicular battery.

13. The system of claim 11, wherein the first range comprises an overvoltage.

14. The system of claim 11, wherein the system comprises a vehicle.

15. The system of claim 3, wherein the at least one capacitor is used as backup-source of power or energy.

16. A method of providing backup power, comprising the steps of:
providing a primary source of voltage;
providing a backup source of voltage;
providing a load;
coupling the backup source to the primary source and to the load to provide voltage to the load when a voltage at the primary power source falls below a certain threshold;
providing a transient detection circuit;
coupling the primary source and the secondary source to the transient detection circuit; and
stopping the backup source from accepting charge during transient conditions detected by the transient detection circuit.

17. The method of claim 16, wherein the transient condition is a transient condition characterized by SAE J1455.

18. The method of claim 16, wherein the backup source comprises one or more double-layer capacitor.

19. The method of claim 16, wherein the primary source is provided in a vehicle.

20. The method of claim 19, wherein the transient condition comprises a voltage that is greater than about 18 volts.
